(19) United States
(12) Patent Application Publication
(10) Pub. No.: US 2008/0062305 A1
(43) Pub. Date: Mar. 13, 2008

(54) Combined multi-image and router apparatus

(76) Inventor: Renaud Lavoie, Laval (CA)

Correspondence Address: OGILVY RENAULT LLP, 1981 MCGILL COLLEGE AVENUE, SUITE 1600, MONTREAL, QC, H3A2Y3, US

(21) Appl. No.: 11/516,652

(22) Filed: Sep. 7, 2006

(51) Int. Cl. H04N 11/02; H04N 9/74

(52) U.S. Cl. 348/387.1; 348/588

(57) ABSTRACT

An apparatus for displaying at least one of a plurality of video signals on a display according to a display selection signal and for simultaneously providing selected video signals according to a providing selection signal, the apparatus comprising a signal conditioning unit for receiving the at least one video signal and for providing at least one corresponding conditioned video signal, a router for receiving the at least one conditioned signal and for providing at least one routed video signal in accordance with the providing selection signal and a multi-image apparatus for receiving and providing to the display at least one of the at least one corresponding conditioned video signal and the at least one routed video signal according to the display selection signal.

### CROSS-REFERENCE TO RELATED APPLICATIONS

This is the first application filed for the present invention.

### TECHNICAL FIELD

This invention relates to the field of video signals. More precisely, the invention pertains to a combined multi-image and router apparatus.

### BACKGROUND OF THE INVENTION

It is desirable to provide a multi-image signal to display using an multi-image apparatus. In such case, the multi-image signal is displayed using a display unit.

At the same time, it may be desirable to provide at least one video signal to another device. In order to achieve this, additional distribution amplifiers may be required as a video signal is typically designed to be transmitted between two points.

As a consequences many expensive equipments are then required resulting in excessive overhead setup costs as well as high maintenance costs.

There is a need for a method and apparatus that will overcome at least one of the above-mentioned drawbacks.

### SUMMARY OF THE INVENTION

According to one aspect of the invention, there is provided an apparatus for displaying at least one of a plurality of video signals on a display according to a display selection signal and for simultaneously providing selected video signals according to a providing selection signal, the apparatus comprising a signal conditioning unit for receiving the at least one video signal and for providing at least one corresponding conditioned video signal, a router for receiving the at least one conditioned signal and for providing at least one routed video signal in accordance with the providing selection signal and a multi-image apparatus for receiving and providing to the display at least one of the at least one corresponding conditioned video signal and the at least one routed video signal according to the display selection signal.

### BRIEF DESCRIPTION OF THE DRAWINGS

Further features and advantages of the present invention will become apparent from the following detailed description, taken in combination with the appended drawings, in which:

FIG. 1 is a block diagram which shows one embodiment of an apparatus for displaying video signals comprising a signal conditioning unit, a router and a multi-image apparatus;

FIG. 2 is block diagram which shows another embodiment of an apparatus for displaying video signals which comprises a signal conditioning unit, a router, a video signal outputting unit and a multi-image apparatus wherein the video signal outputting unit receives at least one routed video signal to output.

FIG. 3 is a block diagram which shows an apparatus for displaying video signals which comprises a signal conditioning unit, a router, a video signal outputting unit and a multi-image apparatus, wherein the router is used to route at least one conditioned video signal to the video signal outputting unit;

FIG. 4 is block diagram which shows a further embodiment of an apparatus for displaying video signals which comprises a signal conditioning unit, a router and a multi-image apparatus wherein the multi-image apparatus receives at least one routed video signal from the router as well as at least one conditioned video signal from the signal conditioning unit;

FIG. 5 is a block diagram which shows a further embodiment of an apparatus for displaying video signals which comprises a signal conditioning unit, a router, a video signal outputting unit and a multi-image apparatus wherein the multi-image apparatus receives at least one routed video signal from the router as well as at least one conditioned video signal from the signal conditioning unit and further wherein at least one routed video signal is provided to the video signal outputting unit; and

FIG. 6 is a flow chart which shows one embodiment for displaying video signals; according to a first step at least one video signal is provided, according to a second step the provided at least one video signal is conditioned, according to a third step the at least one conditioned video signal is routed according to a providing selection signal and according to the fourth step, a multi-image signal is provided for display according to a received display selection signal.

It will be noted that throughout the appended drawings, like features are identified by like reference numerals.

### DETAILED DESCRIPTION

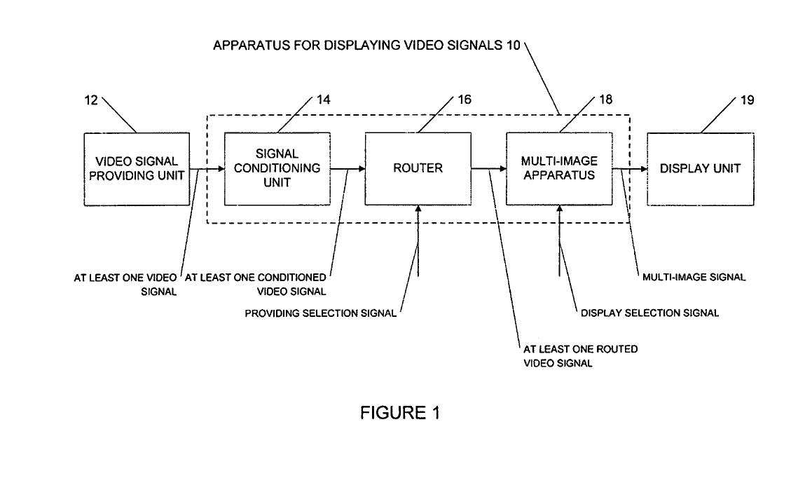

Now referring to FIG. 1, there is shown one embodiment of an apparatus for displaying video signals 10. The apparatus for displaying video signals 10 comprises a signal conditioning unit 14, a router 16 and a multi-image apparatus 18.

The signal conditioning unit 14 receives at least one video signal provided by a video signal providing unit 12. The signal conditioning unit 14 performs a conditioning of the received at least one video signal and provides at least one conditioned video signal. The at least one conditioned video signal is provided to the router 16. The router 16 routes the received at least one conditioned video signal according to a providing selection signal received by router 16. At least one routed video signal is provided by the router 16 to the multi-image apparatus 18 which provides a multi-image signal to display unit 19. The multi-image signal comprises at least one routed video signal and is made in accordance with a received display selection signal. The display unit 19 displays the multi-image signal.

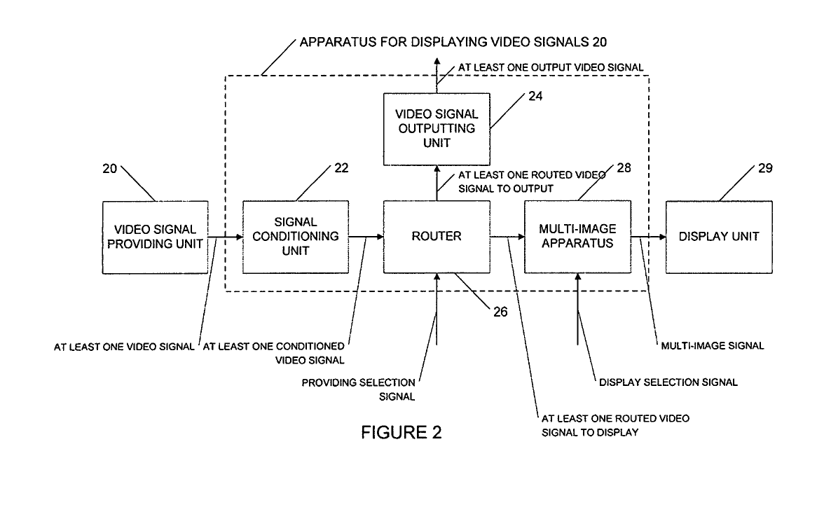

Now referring to FIG. 2, there is shown another embodiment of an apparatus for displaying video signals. The apparatus for displaying video signals 20 comprises a signal conditioning unit 22, a video signal outputting unit 24, a router 26 and a multi-image apparatus 28.

The signal conditioning unit 22 receives at least one video signal provided by a video signal providing unit 20. The signal conditioning unit 22 provides at least one conditioned video signal to the router 26. The router 26 performs a routing of the at least one conditioned video signal according to a providing selection signal. More precisely, the router 26 provides at least one routed video signal to the video signal outputting unit 24 and at least one routed video signal to display to the multi-image apparatus 28. The video signal outputting unit 24 provides at least one output video signal which comprises the received at least one routed video signal to output. The multi-image apparatus 28 provides a multi-image signal to display unit 29. The multi-image signal comprises the received at least one routed video signal to display and is made in accordance with a received display selection signal. The display unit 29 displays the multi-image signal.

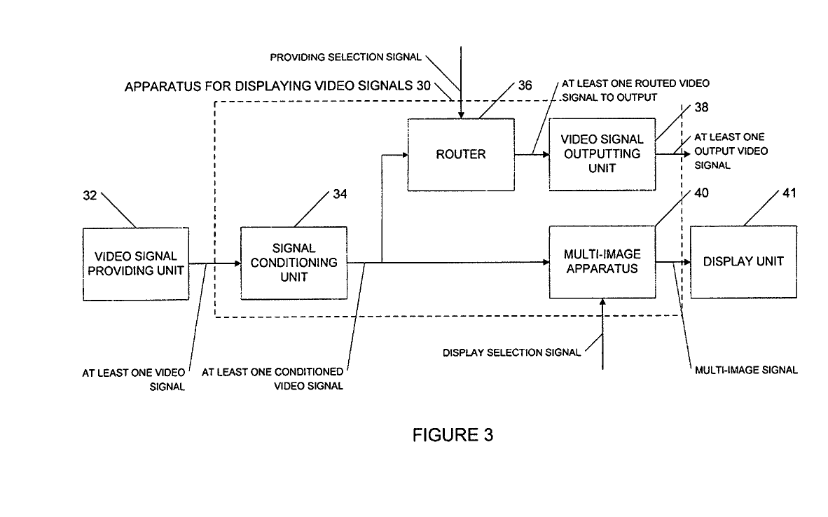

Now referring to FIG. 3, there is shown a further embodiment of an apparatus for displaying video signal 30.

The apparatus for displaying video signals 30 comprises a signal conditioning unit 34, a router 36, a video signal outputting 38 and a multi-image apparatus 40.

The signal conditioning unit 34 receives at least one video signal from a video signal providing unit 32. The signal conditioning unit 34 provides at least one conditioned video signal to the router 36 and to the multi-image apparatus 40. The router 36 performs a routing of the at least one conditioned video signal according to a providing selection signal. More precisely, the router 36 provides at least one routed video signal to the video signal outputting unit 38. The video signal outputting unit 38 provides at least one output video signal which comprises the received at least one routed video signal. The multi-image apparatus 40 receives the at least one conditioned video signal and provides a multi-image signal to display unit 41. The multi-image signal comprises the at least one conditioned video signal and is made in accordance with a received display selection signal. The display unit 41 displays the multi-image signal.

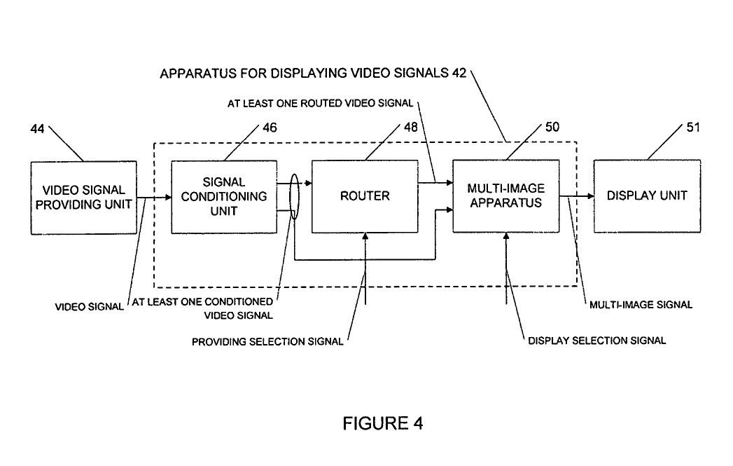

Now referring to FIG. 4, there is shown a further embodiment of an apparatus for displaying video signals 42. The apparatus for displaying video signals 42 comprises a signal conditioning unit 46, a router 48 and a multi-image apparatus 50. The signal conditioning unit 46 receives at least one video signal from a video signal providing unit 44. The signal conditioning unit 46 provides at least one conditioned video signal to the router 48 and to the multi-image apparatus. The router receives the at least one conditioned video signal and provides at least one routed video signal according to a providing selection signal to the multi-image apparatus 50. The multi-image apparatus 50 receives at least one of the at least one routed video signal and the at least one conditioned video signal provided by the signal conditioning unit 46 and provides a multi-image signal to display unit 51. The multi-image signal is made using at least one of the at least one routed video signal and the at least one conditioned video signal in accordance with a received display selection signal. The display unit 51 displays the multi-image signal.

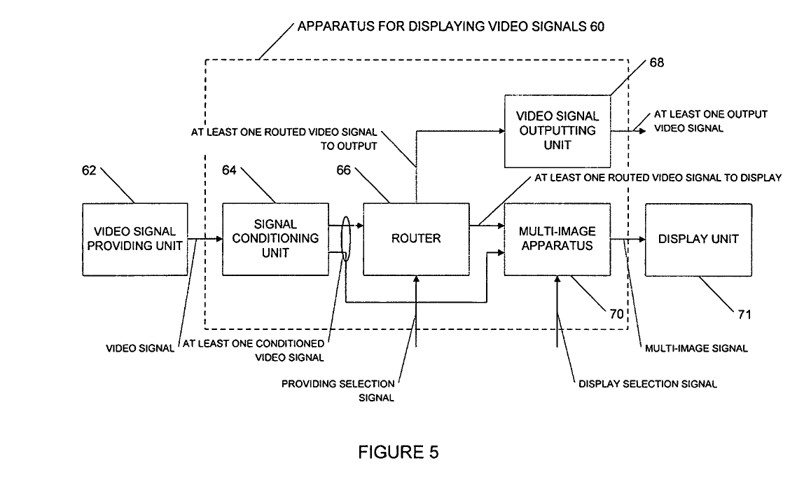

Now referring to FIG. 5, there is shown a further embodiment of the apparatus for displaying video signals 60. The apparatus for displaying video signals 60 comprises a signal conditioning unit 64, a router 66, a video signal outputting unit 68 and a multi-image apparatus 70.

The apparatus for displaying video signals 60 receives at least one video signal provided by the video signal providing unit 62. More precisely, the signal conditioning unit 64 receives the at least one video signal from the video signal providing unit 62 and provides at least one conditioned video signal to the router 66 and to the multi-image apparatus 70. The router 66 receives the at least one conditioned video signal and provides at least one routed video signal according to the providing selection signal received by the router 66. The video signal outputting unit 68 provides at least one output video signal which comprises the at least one routed video signal while the multi-image apparatus 70 provides a multi-image signal to display 71. The multi-image signal is made using at least one of the at least one routed video signal to display and the at least one conditioned video signal in accordance with a received display selection signal. The display unit 71 displays the multi-image signal.

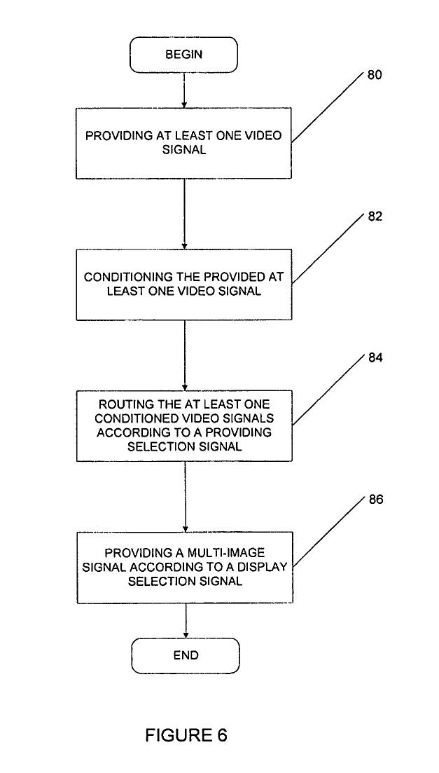

Now referring to FIG. 6, there is shown one embodiment for displaying video signals. According to step 80, at least one video signal is provided. In one embodiment, the at least one video signal is provided by a video signal providing unit.

According to step 82, the provided at least one video signal is conditioned. In one embodiment the at least one video signal is conditioned using a signal conditioning unit.

According to step 84, the at least one conditioned video signal is routed according to a providing selection signal. In one embodiment, the at least one conditioned video signal is routed using a router.

According to step 86, a multi-image signal is provided according to a display selection signal. In one embodiment, the multi-image signal comprises at least one of the at least one conditioned video signal and the at least one routed video signal.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

The embodiments of the invention described above are intended to be exemplary only. The scope of the invention is therefore intended to be limited solely by the scope of the appended claims.

We claim:

1. An apparatus for displaying at least one of a plurality of video signals on a display according to a display selection signal and for simultaneously providing selected video signals according to a providing selection signal, said apparatus comprising:
a signal conditioning unit for receiving said at least one video signal and for providing at least one corresponding conditioned video signal;
a router for receiving said at least one conditioned signal and for providing at least one routed video signal in accordance with said providing selection signal; and
a multi-image apparatus for receiving and providing to said display at least one of said at least one corresponding conditioned video signal and said at least one routed video signal according to said display selection signal.

2. The apparatus as claimed in claim 1, wherein said multi-image apparatus receives said at least one routed video signal and provides at least one of said at least one routed video signal according to said display selection signal.

3. The apparatus as claimed in claim 2, further comprising a video signal outputting unit, further wherein said video signal outputting unit receives and outputs at least one of said at least one routed video signal.

4. The apparatus as claimed in claim 1, further comprising a video signal outputting unit, further wherein said multi-image apparatus receives and provides at least one of said at least one corresponding conditioned video signal according to said display selection signal, further wherein said video signal outputting unit receives and outputs at least one of said at least one routed video signal.

5. The apparatus as claimed in claim 1, further comprising a video signal outputting unit, further wherein said video signal outputting unit receives and outputs at least one of said at least one routed video signal.
